(19) United States
(12) Patent Application Publication
(10) Pub. No.: US 2004/0218228 A1
(43) Pub. Date: Nov. 4, 2004

(54) SHOCK RESISTANT SCANNER

(76) Inventor: Hai-Tao Ma, Hao-Chung City (CN)

Correspondence Address: NAIPO (NORTH AMERICA INTERNATIONAL PATENT OFFICE), P.O. BOX 506, MERRIFIELD, VA, 22116, US

(21) Appl. No.: 10/709,343

(22) Filed: Apr. 29, 2004

(30) Foreign Application Priority Data
Apr. 30, 2003 (TW) 092110184

(51) Int. Cl. G06K 7/10; H04N 1/04

(52) U.S. Cl. 358/474

(57) ABSTRACT

A scanner includes a housing having an upper-case and a low-case, a shaft seat positioned between the upper-case and the lower-case, a shaft set on the shaft seat, a scanning module set on the shaft, a lock for locking the scanning module, and buffer pads. The buffer pads are set between the shaft seat and the shaft and between the shaft seat and either the upper-case or the lower-case. One more buffer pad can be set between the lock and the scanning module.

### BACKGROUND OF INVENTION

1. Field of the Invention

The present invention relates to a scanner, and more specifically, to a scanner with better shock resistance.

2. Description of the Prior Art

A scanner is a common kind of computer peripheral. The scanner is used for scanning a document to generate corresponding data. The scanner then transforms the image data into digital data that can be stored and corrected in a computer. Additionally, it can provide some additional functions. For example, the scanner can fax image data to another fax device via a phone, the scanner can transmit e-mail with the image data through a network, or the scanner can print the data via a printer. Moreover, the scanner can put the transformed data on a network.

The scanner according to the prior art is as shown in FIG. 1. FIG. 1 is a perspective view of a scanner 10 according to the prior art. The scanner comprises a housing 12, a shaft seat 14, a shaft 16, a scanning module 18 and a lock 20. The housing 12 comprises an upper-case 12A and a lower-case 12B. The shaft seat 14 is positioned between the upper-case 12A and the lower-case 12B for fixing the shaft 16. The scanning module 18 is set on the shaft 16 and able to move along the shaft 16. The lock 20 is set on the upper-case 12A for fixing the scanning module 18.

When the scanner 10 scans a document, the scanning module 18 slides along the shaft 16 to scan the document. When the scanner 10 finishes scanning, the scanning module 18 moves to a fixed position on the shaft 16, and the scanner 16 enters standby mode. As long as the scanner 10 does not start scanning, the scanning module 18 will stay at the fixed position. The user can manually move the lock 20 to lock the scanning module 18. The scanning module 18 will then be locked by the lock 20 to avoid shock when the scanner 10 is moved.

There are some other precision instruments in the scanner according to the prior art besides the above-mentioned instruments. For avoiding shock when the scanner is moved, a cushion and a carton will be put around the upper-case 12A and the lower-case 12B of the scanner so that the important elements will not be damaged during drop testing or transportation. However, since present competition in computer peripherals is fierce, manufacturers of scanners need to reduce cost. For achieving the goal of reducing cost, some manufacturers of scanners have resorted to using thinner cushions and worse packing material of lower cost, which in turn reduce the protection for the scanner and shock resistance.

In general, during transportation, the scanner usually is shocked along the vertical direction (as shown in FIG. 1, the vertical shock is in the D direction). The scanner is susceptible to shock at the connections between the shaft seat 14 and the shaft 16, the lock 20 and the scanning module 18, and the shaft seat 16 and either the upper-case 12A or the lower-case 12B because all the connections are fixing points of a rigid manner between two components. As a result, when the thickness of the packing material is reduced or the material is changed, the shock will be sent to the scanner 10 via the buffer material instead of being absorbed. Then the components will be damaged. From the above-mentioned, a shock-resistant and low cost packing scanner needs to be found by the scanner manufacturer.

### SUMMARY OF INVENTION

It is therefore a primary objective of the claimed invention to provide a shock resistant scanner to resolve the problem of damage suffered from reduced buffer action as a result of reducing the thickness of the packing material.

The claimed invention provides a scanner comprising a housing including an upper case and a lower case. The scanner further comprises a shaft seat positioned between the upper case and the lower case, a shaft set on the shaft seat, a scanning module slidably set on the shaft, a lock set on the housing for fixing the scanning module, and buffer pads set between the shaft seat and the shaft and between the shaft seat and either the upper case or lower case with the option of setting one more buffer pad between the lock and the scanning module.

Because the buffer pad can be set on the connection between the shaft seat and the shaft, the connection between the shaft seat and the housing and the connection between the lock and the scanning module, the impact force can be partially absorbed by the buffer pad to efficiently avoid damage during transportation.

### BRIEF DESCRIPTION OF DRAWINGS

FIG. 1 is a perspective view of a scanner according to the prior art.

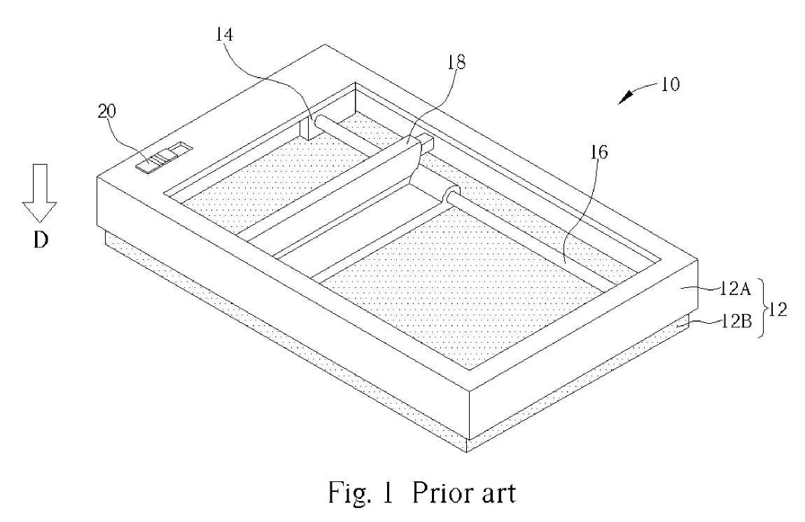

FIG. 2 is a perspective view of a scanner according to the present invention.

FIG. 3 is a sectional view along line 3-3′ of the scanner shown in FIG. 2.

FIG. 4 is a perspective view of another scanner according to the invention.

FIG. 5 is a sectional view along line 5-5′ of the scanner shown in FIG. 4.

### DETAILED DESCRIPTION

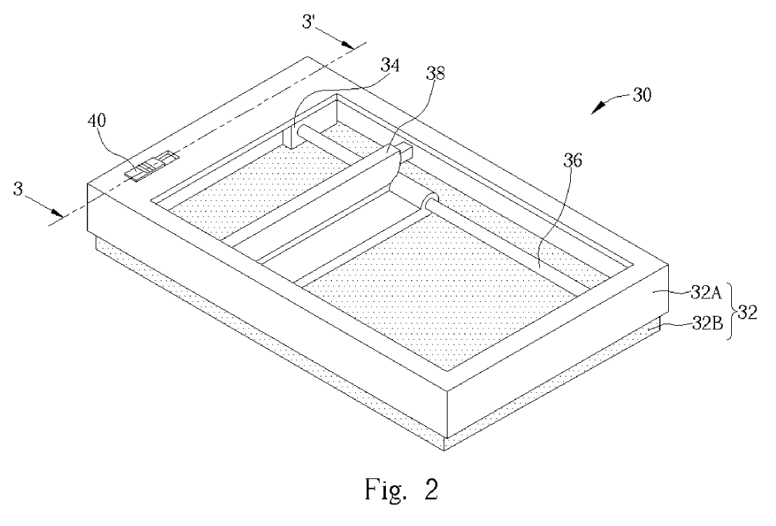

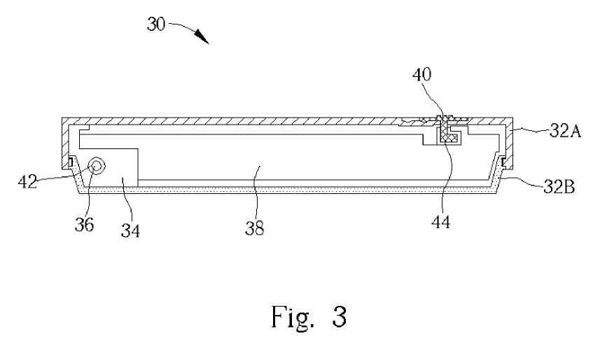

Please refer to FIG. 2 and FIG. 3. FIG. 2 is a perspective view of a scanner 30 according to the present invention. FIG. 3 is a sectional view along line 3-3′ of the scanner 30 shown in FIG. 2. As shown in the figures, the scanner 30 comprises a housing 32 (an upper case 32A and a lower-case 32B), a shaft seat 34 positioned between the upper case 32A and the lower case 32B, a shaft 36 set on the shaft seat 34, a scanning module 38 set on the shaft 36 and able to move along the shaft 36, a lock 40 for fixing the scanning module 38, and two buffer pads 42 and 44.

For fixing the scanning module 40 and two buffer pads 42 and 44 as shown in FIG. 3, the buffer pad 42 set between the shaft seat 34 and the shaft 36 is a ring-shaped elastomer covering the connector between the shaft seat 34 and the shaft 36. The buffer pad 44 is set between the lock 40 and the scanning module 38 to prevent the lock 40 from directly touching the scanning module 38, i.e. the buffer pad 44 can separate the lock 40 and the scanning module 38. The buffer pads 42 and 44 are buffer materials that provide the shock resistance in the rigid connection between components.

When the scanner 30 is in standby mode (the scanner does not scan anything) or is turned off, the scanning module 38 stays in a fixed position. Before moving the scanner 30, the user can manually move the lock 40 to lock the scanning module 38. The scanning module 38 will be locked in place so that the scanning module 38 will not knock against the other parts of the scanner 30 when the scanner is moved. As mentioned earlier, the buffer pad 44 is set between the lock 40 and the scanning module 38, and the buffer pad 42 is set between the shaft seat 34 and the shaft 36. Although the scanner 30 may experience shocks during shipment of the scanner 30, the impact force will be partly absorbed by the buffer pad 42 and buffer pad 44 thus preventing damages to the scanner 30 when certain materials are reduced to save cost.

In the embodiment, the buffer pad 44 on the lock 40 partially or entirely covers the surface of the lock 40. The buffer pad 44 can also be set on the background of the lock 40 or the salient part touching the scanning module 38. Additionally, the buffer pad 44 can also be set into a groove that is on the scanning module 38. The groove can replace the above-mentioned buffer pad set on the lock 40 so that the lock 40 and scanning module 38 are separated by the buffer pad 44 to avoid damage from the shock when the lock 40 moves into the groove and locks the scanning module 38. The shaft seat 34 can be an independent element between the upper-case 32A and the lower case 32B or an integrated element with the upper-case 32A or lower-case 32B.

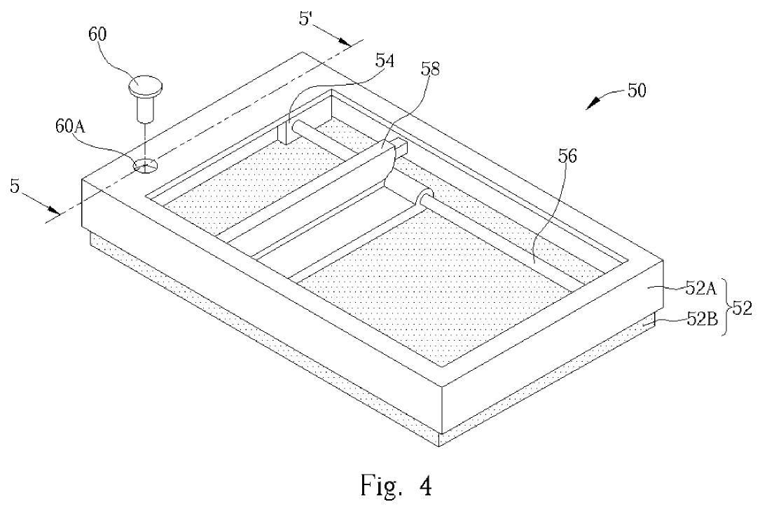

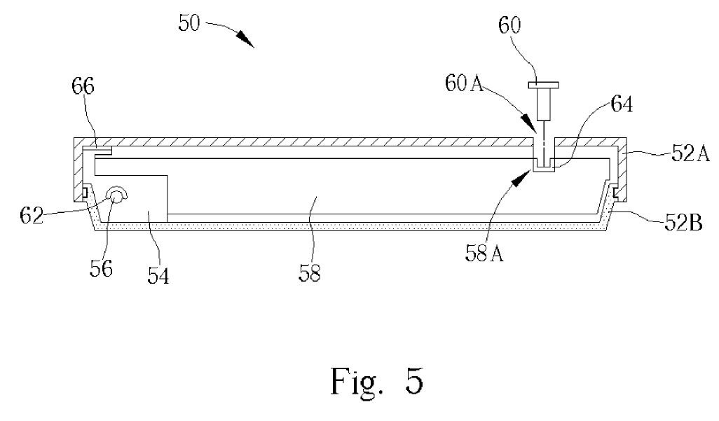

Please refer to FIG. 4 and FIG. 5. FIG. 4 is a perspective view of another scanner 50 according to the present invention. FIG. 5 is a sectional view along the line 5-5′ of the scanner 50 shown in FIG. 4. The scanner 50 comprises an upper case 52A and a lower-case 52B, a shaft seat 54 positioned between the upper case 52A and the lower case 52B, a shaft 56 set on the shaft seat 54, a scanning module 58 set on the shaft 56 and able to move along the shaft 56, a bolt 60 and three buffer pads 62, 64 and 66 made out of the buffer material. The bolt is used for fixing the scanning module 58.

In FIG. 5, the bolt 60 is not fixed on the scanner 50. Before the user moves the scanner 50, the user can put the bolt 50 in a corresponding groove 58A on the scanning module 58 via the bolt hole 60A to prevent the scanning module 58 from moving along the shaft 56. When the scanner 50 is started and about to scan, the bolt 50 can be pulled out from the bolt hole 60A so that the scanning module 58 can freely move to scan.

The buffer pad 62 is an arc-shaped elastomer when the buffer pad 62 is set between the shaft seat 54 and the shaft 56. The buffer pad 62 protects the shaft 56 and the shaft seat 54 by absorbing the shock in the vertical direction. The buffer pad 64 is set on the surface of the groove 58A on the scanning module 58, and the buffer pad 66 is set between the shaft seat 54 and the upper-case 52A. The buffer pad 64 and 66 are the same as the buffer pad 62 and are for protecting the rigid connections when the scanner 50 experiences shocks.

Compared to the scanner according to the prior art, there are buffer pads or elastomer between the connections in the scanner in the present invention to efficiently absorb the shock resulting from movements of the scanner using inadequate packing protection i.e. thinner cushions or worse packing material in an effort by the factory owner to reduce cost.

Those skilled in the art will readily observe that numerous modifications and alterations of the scanners may be made while retaining the teachings of the invention. Accordingly, the above disclosure should be constructed as limited only by the metes and bounds of the appended claims.

What is claimed is:

1. A scanner comprising:
a housing including an upper case and a lower case;
a shaft seat positioned between the upper case and the lower case;
a shaft set on the shaft seat;
a scanning module slidably set on the shaft;
a lock set on the housing for fixing the scanning module; and
a buffer pad set between the shaft seat and the shaft, between the shaft seat and the upper case or lower case, or between the lock and the scanning module.

2. The scanner of claim 1 wherein the buffer pad is an arc-shaped elastomer set between the shaft seat and the shaft.

3. The scanner of claim 1 wherein the buffer pad is a ring-shaped elastomer set between the shaft seat and the shaft.

4. The scanner of claim 1 wherein the buffer pad is an elastomer laid on the lock and set between the lock and the scanning module.

5. The scanner of claim 1 wherein the buffer pad is an elastomer set into a groove which is between the lock and the scanning module.

6. A scanner comprising:
a housing including an upper case and a lower case;
a shaft seat set between the upper case and the lower case;
a shaft set on the shaft seat;
a scanning module slidably set on the shaft; and
a buffer pad set between the shaft seat and the shaft or between the shaft seat and the upper case or the lower case.

7. The scanner of claim 6 wherein the buffer pad is an arc-shaped elastomer set between the shaft seat and the shaft.

8. The scanner of claim 6 wherein the buffer pad is a ring-shaped elastomer set between the shaft seat and the shaft.

9. The scanner of claim 6 wherein the scanner further comprises a bolt for fixing the scanning module.

10. The scanner of claim 9 wherein the surface of the bolt is covered with an elastomer.

11. The scanner of claim 9 wherein a groove that contains the bolt in the scanning module is lined with an elastomer.
